(19) United States
(12) Patent Application Publication
(10) Pub. No.: US 2007/0230461 A1
(43) Pub. Date: Oct. 4, 2007

(54) Method and system for video data packetization for transmission over wireless channels

(75) Inventors: Harkirat Singh, Santa Clara, CA (US); Huai-Rong Shao, San Jose, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/728,244

(22) Filed: Mar. 22, 2007

Related U.S. Application Data
(60) Provisional application No. 60/787,381, filed on Mar. 29, 2006.

(51) Int. Cl. H04L 12/56

(52) U.S. Cl. 370/389

(57) ABSTRACT

A method and system for transmitting video information from a sender to a receiver over wireless channels, by inputting a frame of video information at the sender, packetizing the video information and transmitting the video packet from the sender to the receiver over a wireless channel. Packetizing the video information is performed by segmenting the frame into one or more segments of video information, constructing a data payload from one of the segments, constructing a video header including information describing said one segment, forming a video packet from the video header and the data payload. The video header in each video packet uniquely defines the video information in the data payload of the video packet for the receiver to reconstruct the video frame for proper display of the data payload in a video stream.

### RELATED APPLICATION

This application claims priority from U.S. Provisional Patent Application Ser. No. 60/787,381, filed on Mar. 29, 2006, incorporated herein by reference.

### FIELD OF THE INVENTION

The present invention relates to transmission of video information and in particular, to transmission of video information over wireless channels.

### BACKGROUND OF THE INVENTION

With the proliferation of high quality video, an increasing number of electronics devices (e.g., consumer electronics devices) utilize high definition (HD) video which can require multiple gigabit per second (Gbps) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices are connected which do not have the bandwidth to carry the uncompressed HD signal, and do not provide an air interface to transmit uncompressed video over a 60 GHz band. There is, therefore, a need for a method and system for wireless transmission of uncompressed video information which addresses the above shortcomings.

### BRIEF SUMMARY OF THE INVENTION

The present invention provides a method and system for transmitting video information from a sender to a receiver over wireless channels, by inputting a frame of video information at the sender, packetizing the video information, and transmitting the video packet from the sender to the receiver over a wireless channel. Packetizing the video information comprises segmenting the frame into one or more segments of video information, constructing a data payload from one of the segments, constructing a video header including information describing said one segment, and forming a video packet from the video header and the data payload. The video header in each video packet uniquely defines the video information in the data payload of the video packet for the receiver to reconstruct the video frame for proper display of the data payload in a video stream.

Transmitting the video packet from the sender to the receiver further comprises transmitting the video packet from the sender to the receiver over a high-rate channel, and receiving an acknowledgment from the receiver over a low-rate channel. Preferably, transmitting the video packet from the sender to the receiver over a wireless channel further comprises transmitting the video packet from the sender to the receiver by directional transmission beams over the high-rate channel, and receiving an acknowledgement from the receiver by directional transmission over the low-rate channel.

Preferably, the video header comprises a media adaptation control field which includes a video frame start indicator, that indicates whether the video packet data payload is the start of a video frame or a field. The media adaptation control field further includes partitioning mode information that indicates the manner of pixel partitioning, and encoding mode information that indicates the manner of any encoding of the video packet data payload by the sender. The video header further comprises video frame number information that indicates a sequence number of the video frame which the data payload of the video packet belongs to.

Preferably, the video header further comprises position information in the video frame which the video packet data payload starts from, and a playback deadline timestamp for the data payload. Upon receiving the video packet, the receiver utilizes the information in the video header of the video packet to retrieve data from the video packet data payload and recreate the video information of the frame.

These and other features, aspects and advantages of the present invention will become understood with reference to the following description, appended claims and accompanying figures.

### BRIEF DESCRIPTION OF THE DRAWINGS

FIG. 1A shows an example Wireless High Definition (WiHD) system comprising a network of multiple wireless devices implementing a process of packetizing uncompressed HD video information for transmission over wireless channels, according to the present invention.

FIG. 1B shows example directional beams for transmission of video information in the system of FIG. 1A.

FIG. 2 shows example functional block diagrams of a sender device and a receiver device in the system of FIG. 1A, implementing a process of packetizing uncompressed HD video information for transmission over wireless channels, according to the present invention.

FIG. 3 shows another example functional block diagram of a sender device and a receiver device in the system of FIG. 1A, implementing a process of packetizing uncompressed HD video information without Media Access Control (MAC) headers for transmission over wireless channels, according to the present invention.

FIG. 4 illustrates an example of an uncompressed video packetization process, according to the present invention.

FIG. 5 shows details of an example video data header for a video packet, according to the present invention.

FIG. 6 shows details of video information in an example video frame.

FIG. 7 shows example details of a media adaptation control field in the video header of FIG. 5.

FIG. 8 shows a flowchart of an example process for packetizing a video data frame at a transmitter, according to the present invention.

FIG. 9 shows a flowchart of an example process for handling a video data frame at a receiver, according to the present invention.

### DETAILED DESCRIPTION OF THE INVENTION

The present invention provides a method and system for packetizing video information, such as uncompressed HD video pixels, for transmission over wireless channels (e.g., radio frequency (RF)). In one embodiment, it is assumed that the wireless medium has enough bandwidth to support uncompressed HD 1080p video. A wireless communication system that supports transmission of such video information is referred to herein as a WiHD system, and implements a method of uncompressed video packetization at a sender that helps a receiver reconstruct the transmitted video frames and display them accurately.

An example WiHD system utilizes a 60 GHz-band mmWave technology to support a PHY (physical layer) data transmission rate of multi-Gbps, and can be used for transmitting uncompressed high-definition television (HDTV) signals wirelessly. The WiHD system includes wireless devices with multiple antennas, wherein directional beams are formed for transmitting/receiving HD data. Such a system can support a 1080p HD format which requires a raw data rate of 2.98 Gbps (frame_size×number_of_frames_per_sec=1920×1080×3×8*60).

A video frame is divided into multiple scan lines, each scan line including an integer number of pixels, wherein each pixel comprises multiple components (e.g., color, luminance). Quantization for pixel depth, or bits per component (bitplane), may be 8-bit, 10-bit, 12-bit or 16-bit values. In one example, pixel components include either a color component (chrominance) or a luminance component of the video. Considering an 8-bit quantization, a one 1080p scan line includes 46,080 bits. And, considering 60 frames/second, one second of uncompressed video (1080p) comprises 60×3×8×1920×1080=2.98 gigabits.

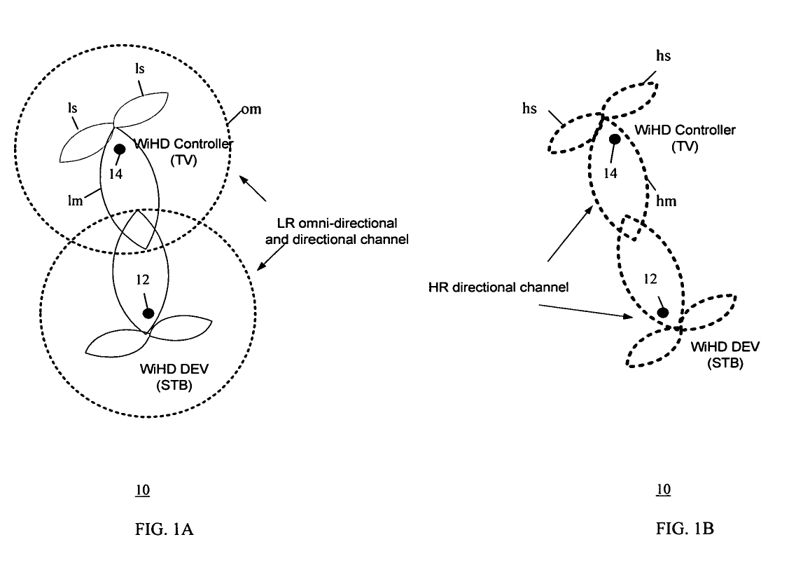

FIG. 1A shows an example WiHD system comprising a network 10 of multiple WiHD devices 12 and 14. Each WiHD device utilizes two channels: a symmetric low-rate (LR) control channel, and an asymmetric high-rate (HR) data channel. The LR channel operates in two modes: (1) an omni-directional mode, which is used for the transmission of control data such as beacon, association/disassociation, device discovery, acknowledgement (ACK), etc., wherein the omni-directional mode supports data rates of multi-Mbps (megabits per second); and (2) a directional or beamformed mode, which is used for transmitting audio streams, wherein the beamformed mode supports data rates of multi-Mbps.

The HR data channel is a directional (beamformed) channel which is used for the transmission of uncompressed video from the WiHD sender 12 to the WiHD receiver 14. An example scenario shown in FIG. 1B, involves the WiHD sender 12 (e.g., a set-top box (STB)) transmitting uncompressed video to the WiHD receiver 14 (e.g., HDTV), over a HR channel. The HR channel supports data rates of multi-Gbps. In this scenario, the LR channel is used to send acknowledgement (ACKs) from the WiHD receiver 14 to the WiHD sender 12. FIG. 1A further shows an omni-directional transmission om, main lobes lm, and side lobes ls, for the LR channel. FIG. 1B shows directional beams, comprising main lobes hm and side lobes hs, for the HR channel.

In many wireless communication systems, a frame structure is used for data transmission between a transmitter and a receiver. For example, the IEEE 802.11 standard uses frame aggregation in a Media Access Control (MAC) layer and a physical (PHY) layer. In a typical transmitter, a MAC layer receives a MAC Service Data Unit (MSDU) and attaches a MAC header thereto, in order to construct a MAC Protocol Data Unit (MPDU). The MAC header includes information such a source addresses (SA) and a destination address (DA). The MPDU is a part of a PHY Service Data Unit (PSDU) and is transferred to a PHY layer in the transmitter to attach a PHY header (i.e., PHY preamble) thereto to construct a PHY Protocol Data Unit (PPDU). The PHY header includes parameters for determining a transmission scheme including a coding/modulation scheme. Before transmission as a packet from a transmitter to a receiver, a preamble is attached to the PPDU, wherein the preamble can include channel estimation and synchronization information.

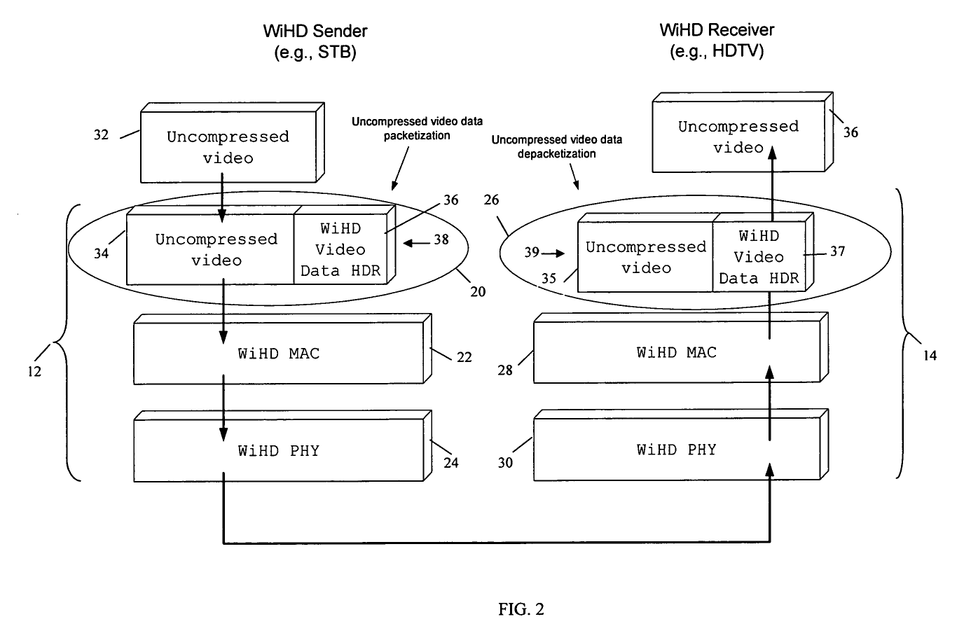

FIG. 2 shows a more detailed functional block diagram of the WiHD sender 12 and the WiHD receiver 14, implementing a WiHD video data packetization process, according to the present invention. The WiHD sender 12 comprises a packetization module 20, a MAC layer (WiHD MAC) 22 and a PHY layer (WiHD PHY) 24. The WiHD receiver 14 comprises a depacketization module 26, a MAC layer (WiHD MAC) 28 and a PHY layer (WiHD PHY) 30.

The WiHD sender 12 inputs uncompressed video information 32. The packetization module 20 generates a data payload 34 from the uncompressed video information 32, and further appends a WiHD Video Data HDR (Header) 36 to the data payload 34 to form a WiHD packet 38. The WiHD packet 38 is provided to the WiHD MAC 22, which converts the WiHD packet 38 into a MAC packet with a WiHD MAC header, cyclic redundancy checksum (CRC), and provides the MAC packet to the WiHD PHY 24 for transmission to the receiver 14 over a HR channel.

The WiHD PHY 30 of the WiHD receiver 14 receives the transmitted information and provides that information to the WiHD MAC 28 for detecting the CRC, and generating a WiHD packet 39 including a data payload 35 which contains uncompressed video information bits and a WiHD Video HDR 37. The data payload 35 at the WiHD receiver 14 corresponds to the data payload 14 at the WiHD sender 12. Similarly, the WiHD Video HDR 37 at the WiHD receiver 14 corresponds to the WiHD Video HDR 36 at the WiHD sender 12. The depacketization module 26 then extracts uncompressed video information 36 from the data payload 35 and uses the information in the WiHD Video HDR 37 to reconstruct the video frame, such as for proper display of the data payload in a video stream on a sink device, such as a HD display device.

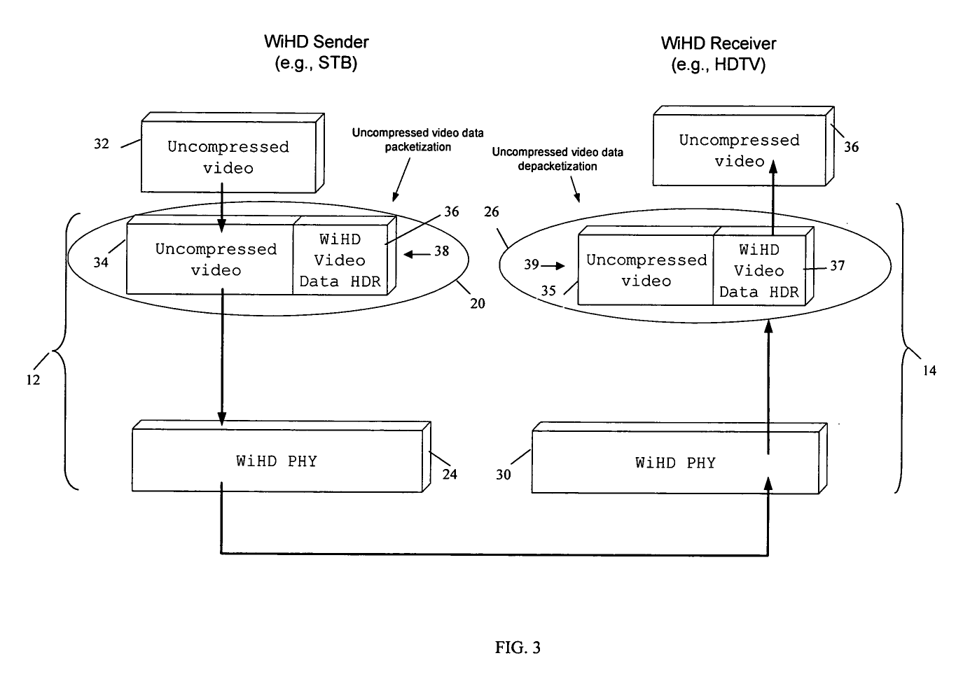

FIG. 3 shows another functional block diagram of the WiHD sender 12 and the WiHD receiver 14, forming a system implementing an example WiHD video data packetization process, wherein the sender WiHD MAC 22 and the receiver WiHD MAC 28 are not utilized. In this example, a reservation based channel access scheme is assumed. Hence, all devices in the network know in advance about the details of active devices within a reserved time block, a priori, which is communicated using beacons. Thus, it is possible to completely skip the WiHD MAC header (and WiHD MAC elements 22, 28), and thereby reduce the MAC overhead. In this scheme, after appending the WiHD Video Data HDR 36, the WiHD packet 38 is directly sent to the WiHD PHY 24 of the sender 12 for transmission to the receiver 14. The CRC is appended in the WiHD PHY 24 at the sender, and checked in the WiHD PHY 30 at the receiver. In either case, a WiHD video data packetization scheme according to the present invention is independent of whether the WiHD packet 38 is sent with a WiHD MAC header or without a WiHD MAC header.

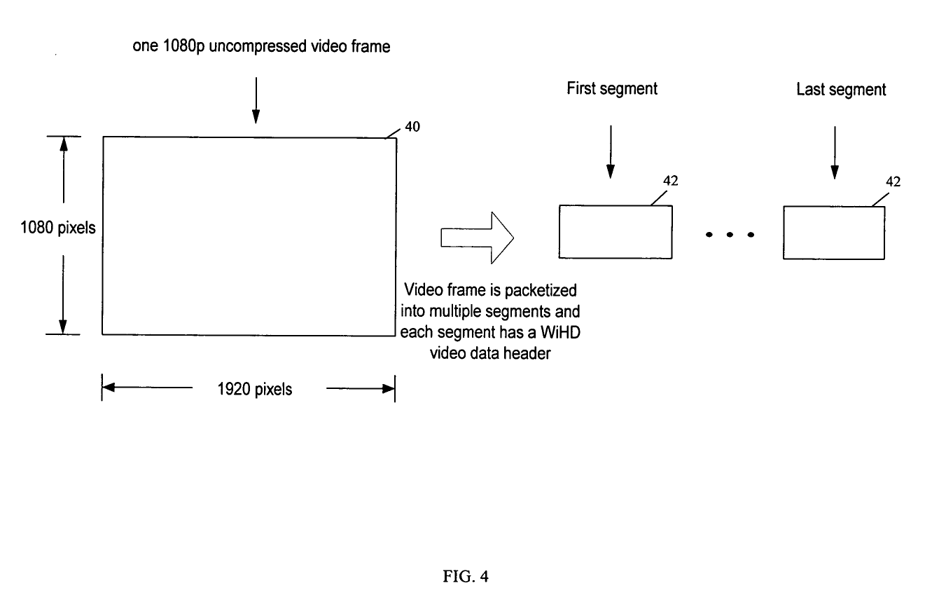

FIG. 4 illustrates an example of an uncompressed video packetization process, according to the present invention. In this example, an uncompressed video frame 40 is segmented into multiple segments 42, wherein each segment 42 is converted to a data payload 34 and a WiHD Video Data HDR 36 is appended thereto to construct a WiHD video packet 38. The WiHD Video Data HDR 36 uniquely defines the video data in the payload 34 of the WiHD video packet 38, to allow the receiver 14 to accurately display the video data. In a progressive video scheme the pixels are scanned line by line. However, in an interlaced scheme, the pixels are scanned every other line, such that one video frame is divided into two sub-frames called an even line field (first field) and an odd line field (second field).

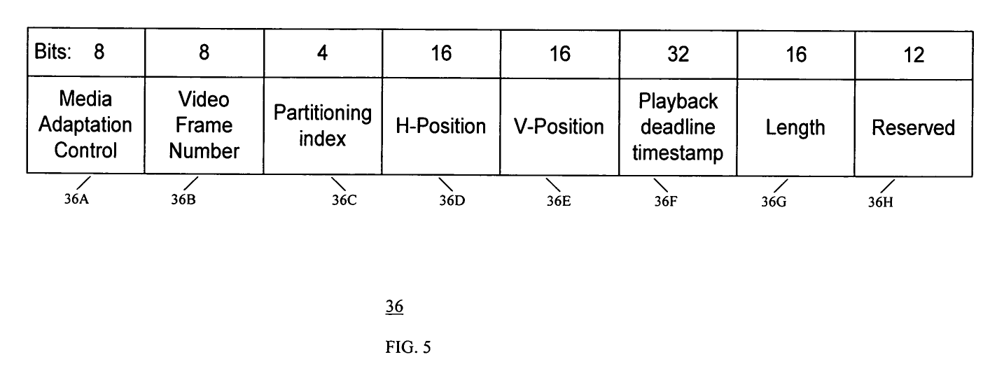

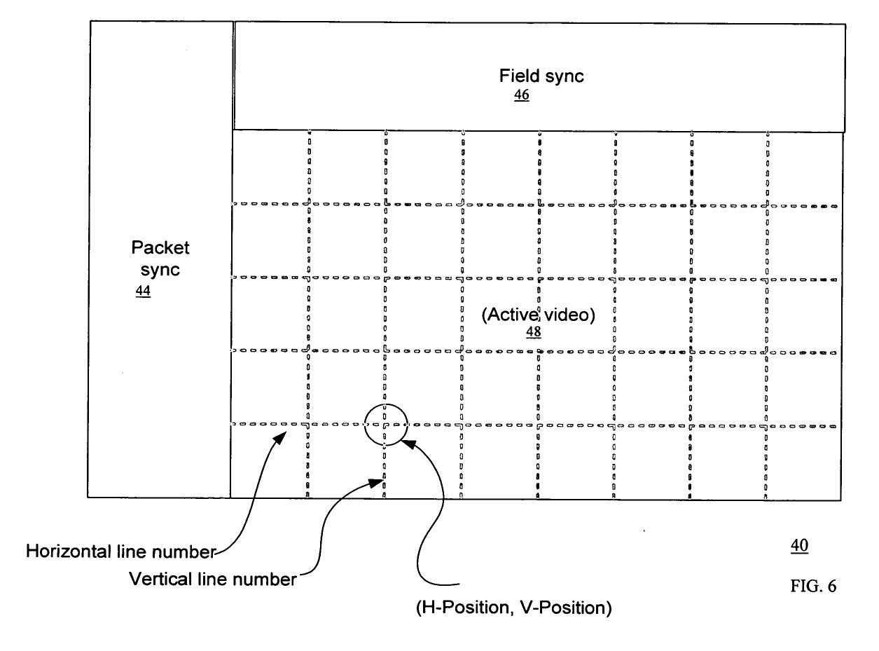

FIG. 5 shows the details of the WiHD Video Data HDR 36, including:
A media adaptation control field 36A (8 bits) includes multiple subfields, wherein a Video Frame Start indication sub-field is used to indicate that a sub-packet carries the start information of a video frame, a Pixel partitioning mode sub-field is used to indicate the partitioning mode used for the transmission of the sub-packet, and an Encoding mode sub-field is used to indicate the encoding method used for video data in the sub-packet.
A Video Frame Number field 36B (8 bits) is an unsigned character field, representing the video frame number. For progressive video, the Video Frame Number is incremented sequentially. After reaching the maximum value of 0×ff, the next value would be 0. All packets belonging to the same video frame have identical Video Frame Number values. For interlaced video, the Video Frame Number is incremented by two. Thus, each video frame will have two Video Frame Numbers. All packets belonging to the first (even) field in the frame have an even Video Frame Number and all packets belonging to the second (odd) field in that frame have an odd Video Frame Number. For example, for the very first uncompressed video frame, the packets belonging to the first field have their Video Frame Number set to 0, and the packets belonging to the second field will have their Video Frame Number set to 1. Therefore, the same video frame has two Video Frame Numbers. Assuming, a frame update frequency of 60 Hz (i.e., 60 frames per second), the Video Frame Number sub-field wraps around in 4.2 seconds.
A Partitioning index field 36C (4 bits) indicates the partition of video data carried in the sub-packet.
An H-Position field 36D (16 bits) and a V-Position field 36E (16 bits) for a video frame such as frame 40 in FIG. 6. As shown by example in FIG. 6, a video frame 40 contains Packet sync information 44 (a standard component of a video frame), Field sync information 46 (a standard component of a video frame), and Active video data 48, wherein the Packet sync and Field sync information include control data and the Active video includes uncompressed video data. The Active video data 48 is divided into horizontal and vertical lines. Furthermore, each pixel in the Active video data can be represented in terms of H-Position and V-Position. As such, the H-Position field 36D represents the number of the horizontal line the video data starts from. The V-Position field 36E represents the number of the vertical line the video data starts from.
A Playback deadline timestamp field 36F (32 bits) comprises a timestamp indicating the playback deadline of the sub-packet video data.
A Length field 36G (16 bits) denotes the length of the video data payload 34, for example, in octets.
A Reserved bits field 36H is set to 0 on transmission from the WiHD sender 12, and is ignored by the WiHD receiver 14.

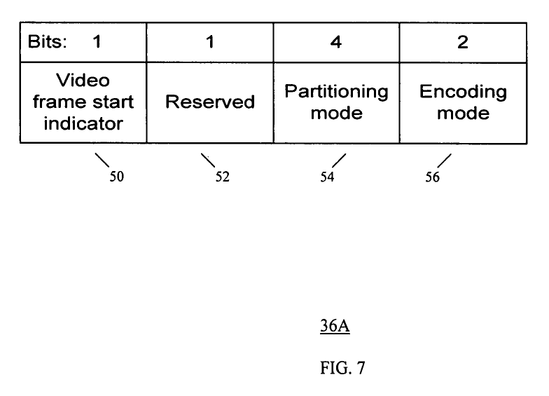

FIG. 7 shows the details of the Media Adaptation Control field 36A, including the following subfields:
A Video frame start indicator subfield 50 (1 bit) indicates whether this packet is the start of a video frame (or a field in the case of interlaced video).
A Reserved subfield 52 (1 bit).
A Partitioning mode subfield 54 (4 bits) indicates how pixel partitioning into different packets is performed.

An Encoding mode subfield 56 (2 bits) indicates a video encoding mode when the information in the packet data payload is spatially encoded by the sender. This allows the receiver to decode the packet data payload.

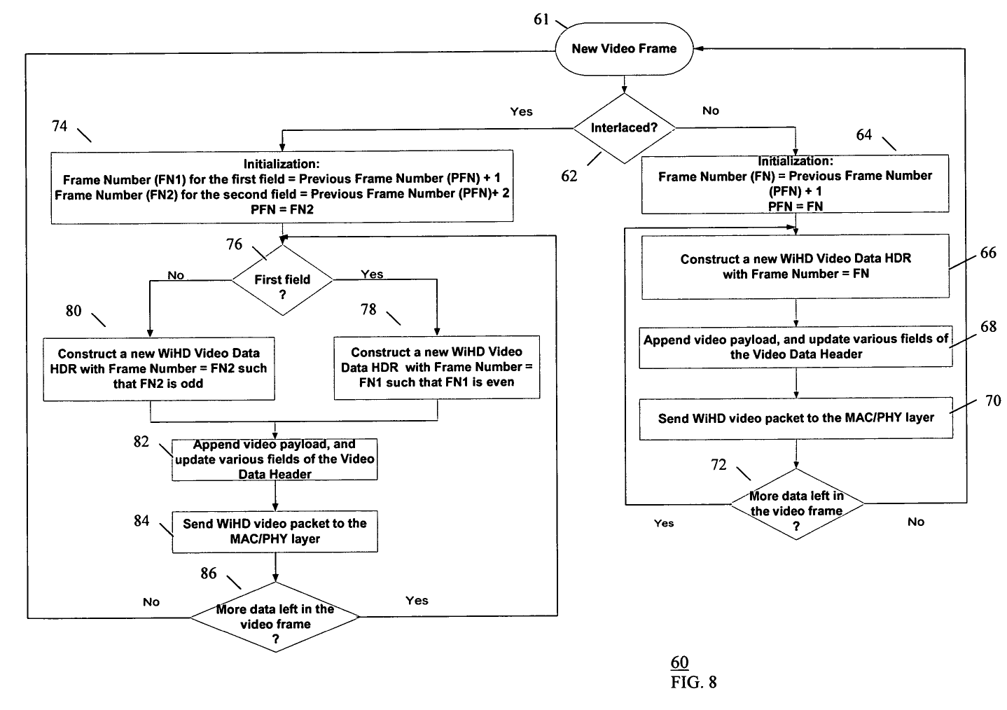

FIG. 8 shows a flowchart of a process 60 for WiHD video data frame handling at the sender 12, according to the present invention, comprising the steps of:
Step 61: Receive a new video frame 40 of uncompressed video information and construct a WiHD payload 34, therefrom.
Step 62: Determine if the frame 40 is interlaced? If yes, go to step 74, otherwise go to step 64.
Step 64: Perform initialization for parameters Frame Number (FN) and Previous Frame Number (PFN), wherein: FN=PFN+1 and PFN=FN.
Step 66: Construct new WiHD Video Data HDR 36 and set the Video Frame Number 36B equal to the FN.
Step 68: Append the Video Data HDR 36 to the payload 34 to create the WiHD packet 38, and update fields in the Video Data HDR 36 according to the characteristics of the payload 34 (i.e., using an update timestamp, media adaptation control, H & V positions and length, from the fields of the Video Data HDR 36).
Step 70: Send the WiHD packet 38 to the WiHD MAC/WiHD PHY 22, 24 for transmission to the receiver.
Step 72: Determine if additional video information remains in the frame 40? If not, go back to step 61 to process the next new frame, otherwise go back to step 66 to construct another WiHD packet.
Step 74: Perform initialization for parameters Frame Number 1 (FN1) for a first field (i.e., even scan lines) of the interlaced frame 40, and Frame Number 2 (FN2) for a second field (i.e., odd scan lines) of the interlaced frame 40, wherein: FN1=PFN+1, FN2=PFN+2 and PFN=FN2.
Step 76: Determine if processing the first field? If yes, go to step 78, otherwise go to step 80.
Step 78: Construct a new WiHD Video Data HDR 36, and set the Video Frame Number 36B equal to the FN1 so that FN1 is even. Go to step 82.
Step 80: Construct a new WiHD Video Data HDR 36, and set the Video Frame Number 36B equal to the FN2 so that the FN2 is odd. Go to step 82.
Step 82: Append the Video Data HDR 36 to the payload 34 to create the WiHD packet 38, and update fields in the Video Data HDR 36 according to the characteristics of the payload 34 (i.e., using an update timestamp, media adaptation control, H & V positions and length, from the fields of the Video Data HDR 36.
Step 84: Send the WiHD packet 38 to the WiHD MAC/WiHD PHY 22, 24 for transmission to the receiver.
Step 86: Determine if additional video information remains in the frame 40? If not, go back to step 61 to process the next new frame, otherwise go back to step 76 to construct another WiHD packet.

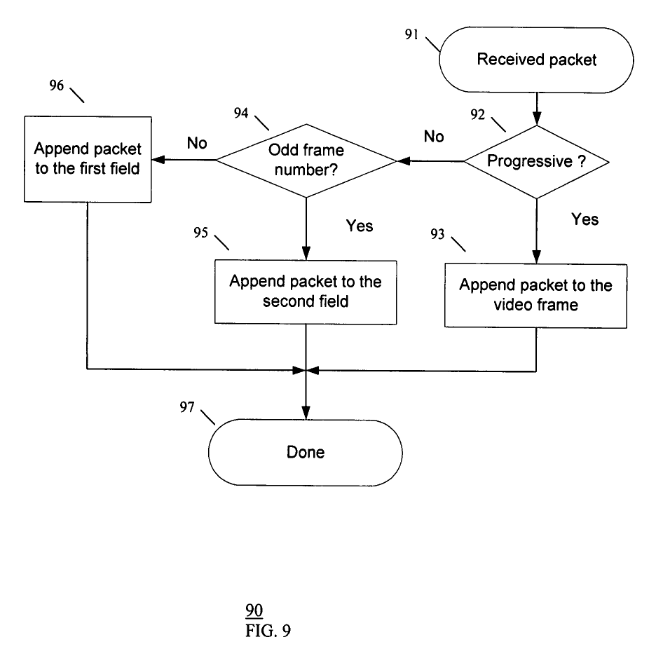

Upon receiving each WiHD packet, the receiver 14 performs the reverse of the above steps to recreate the uncompressed video frame using the information in the Video Data HDR 36 for each WiHD packet. The WiHD Video Data HDR 36 is optimized to reduce transmission overhead. FIG. 9 shows a flowchart of an example process 90 for WiHD video data frame handling at the receiver 14, according to the present invention, comprising the steps of:
Step 91: Receive packet.
Step 92: Determine if progressive video information? If yes, go to step 93, otherwise go to step 95.
Step 93: Append packet to the video frame. Go to step 97.
Step 94: Determine if the current video frame number is odd? If yes, go to step 95, otherwise go to step 96.
Step 95: Append packet to the second field, go to step 97.
Step 96: Append packet to the first field, go to step 97.

Step 97: Processing of the received packet is complete.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of transmitting video information from a sender to a receiver over wireless channels, comprising:
inputting a frame of video information at the sender;
packetizing the video information by:
segmenting the frame into one or more segments of video information;
constructing a data payload for a packet from one of the segments;
constructing a video header including information describing said one segment, wherein the video header uniquely defines the video information in the data payload;
forming a video packet from the video header and the data payload; and
transmitting the video packet from the sender to the receiver over a wireless channel.

2. The method of claim 1 wherein transmitting the video packet from the sender to the receiver further comprises transmitting the video packet from the sender to the receiver over a high data-rate channel.

3. The method of claim 2 further comprising the step of the receiver sending an acknowledgment for the packet to the sender over a low data-rate channel.

4. The method of claim 3 wherein:
transmitting the video packet from the sender to the receiver over a wireless channel further comprises transmitting the video packet from the sender to the receiver by directional transmission beams over the high-rate channel; and
receiving an acknowledgement includes receiving the acknowledgement from an directional transmission by the receiver over the low-rate channel.

5. The method of claim 1 wherein transmitting the video packet from the sender to the receiver further comprises adding a MAC header, a cyclic redundancy checksum (CRC) to the video packet to generate a MAC packet, and transmitting the MAC packet to the receiver.

6. The method of claim 1 further comprising the steps of:
receiving the video packet at the receiver; and
utilizing the information in the video header of the video packet to retrieve data from the video packet data payload and recreate video information of the frame.

7. The method of claim 1 wherein the video header in each video packet defines the video information in the data payload of the video packet for the receiver to reconstruct the video frame for proper display of the data payload in a video stream.

8. The method of claim 7 wherein the video header comprises a media adaptation control field which includes a video frame start indicator that indicates whether the video packet data payload is the start of a video frame or field.

9. The method of claim 8 wherein the media adaptation control field further includes partitioning mode information that indicates a manner of pixel partitioning in frame segmentation for the packet payload.

10. The method of claim 8 wherein the media adaptation control field further includes encoding mode information that indicates the manner of any encoding of the video packet data payload by the sender.

11. The method of claim 7 wherein the video header further comprises video frame number information which, for progressive video information, indicates a sequence number of the video frame which the data payload of the video packet belongs to.

12. The method of claim 7 wherein the video header further comprises video frame number information which, for interlaced video information, indicates an even frame number for a packet in a first field of an interlaced frame, and an odd frame number for a packet in a second field of an interlaced frame.

13. The method of claim 8 wherein the video header further comprises position information in the video frame which the video packet data payload starts from.

14. The method of claim 8 wherein the video header further comprises a playback deadline timestamp which, for interlaced video information, indicates the sampling instant of a field to which the data payload of the video packet belongs to, thereby allowing the receiver to recreate proper display timing of the data payload in a video stream.

15. The method of claim 8 wherein the video header further comprises length information indicating the length of the data payload of the video packet.

16. A method of transmitting video information from a sender to a receiver over wireless channels, comprising the steps of:
inputting a frame of video information at the sender;
packetizing the video information by:
segmenting the frame into one or more segments of video information;
constructing a data payload for a packet from one of the segments;
constructing a video header including information describing said one segment;
forming a video packet from the video header and the data payload; and
transmitting the video packet from the sender to the receiver by directional transmission beams over a wireless channel;
wherein the video header in each video packet uniquely identifies the video information in the data payload of the video packet for the receiver to recreate the video information of the frame.

17. The method of claim 16 wherein the video header comprises a media adaptation control field which includes video frame start indicator that indicates whether the video packet data payload is the start of a video frame or field.

18. The method of claim 17 wherein the media adaptation control field further includes partitioning mode information that indicates the manner of pixel partitioning in segmenting a frame into packets.

19. The method of claim 18 wherein the media adaptation control field further includes encoding mode information that indicates any encoding of the video packet data payload by the sender.

20. The method of claim 16 wherein the video header further comprises video frame number information which, for progressive video information, indicates a sequence number of the video frame which the data payload of the video packet belongs to.

21. The method of claim 20 wherein the video header further comprises video frame number information which, for interlaced video information, indicates an even frame number for a packet in a first field of an interlaced frame and an odd frame number for a packet in a second field of an interlaced frame.

22. The method of claim 21 wherein the video header further comprises position information in the video frame which the video packet data payload starts from.

23. The method of claim 22 wherein the video header further comprises a playback deadline timestamp which indicates the playback deadline of the video data payload.

24. The method of claim 23 wherein the video header further comprises length information indicating the length of the data payload of the video packet.

25. The method of claim 24 further comprising the steps of:
receiving the video packet at the receiver; and
utilizing the information in the video header of the video packet to retrieve data from the video packet data payload and recreate video information of the frame.

26. The method of claim 16 wherein the video information in the frame comprises video pixels representing uncompressed video information.

27. The method of claim 16 wherein the same frame format is used for interlaced and progressive video information.

28. A transmitter for transmission of one or more video frames to a receiver over wireless channels, comprising:
a packetizer configured to segment a frame of video information into one or more segments, and construct a video packet including a data payload from one of the segments, and a video header including information describing said one segment, wherein the video header uniquely defines the video information in the data payload; and
a communication module configured to transmit the video packet from the sender to the receiver over a wireless channel.

29. The transmitter of claim 28 wherein the communication module is configured to transmit the video packet from the sender to the receiver over a high data-rate channel.

30. The transmitter of claim 29 wherein the receiver sends an acknowledgment for the packet to the sender over a low data-rate channel.

31. The transmitter of claim 30 wherein the communication module is configured to transmit the video packet to the receiver by directional transmission beams over the high-rate channel, and to receive an acknowledgement from the receiver from a directional transmission by the receiver over the low data-rate channel.

32. The transmitter of claim 28 wherein the communication module is further configured to add a MAC header, a cyclic redundancy checksum (CRC) to the video packet to generate a MAC packet, and to transmit the MAC packet to the receiver.

33. The transmitter of claim 28 wherein the receiver utilizes the information in the video header of the video packet to retrieve data from the video packet data payload and recreate video information of the frame.

34. The transmitter of claim 28 wherein the video header in each video packet uniquely defines the video information in the data payload of the video packet for the receiver to reconstruct the video frame for proper display of the data payload in a video stream.

35. The transmitter of claim 34 wherein the video header comprises a media adaptation control field which includes a video frame start indicator that indicates whether the video packet data payload is the start of a video frame or field.

36. The transmitter of claim 35 wherein the media adaptation control field further includes partitioning mode information that indicates a manner of pixel partitioning in frame segmentation for the packet payload.

37. The transmitter of claim 35 wherein the media adaptation control field further includes encoding mode information that indicates the manner of any encoding of the video packet data payload by the sender.

38. The transmitter of claim 35 wherein the video header further comprises video frame number information which, for progressive video information, indicates a sequence number of the video frame which the data payload of the video packet belongs to.

39. The transmitter of claim 34 wherein the video header further comprises video frame number information which, for interlaced video information, indicates an even frame number for a packet in a first field of an interlaced frame and an odd frame number for a packet in a second field of an interlaced frame.

40. The transmitter of claim 35 wherein the video header further comprises position information in the video frame which the video packet data payload starts from.

41. The transmitter of claim 35 wherein the video header further comprises a playback deadline timestamp which, for interlaced video information, indicates the sampling instant of a field to which the data payload of the video packet belongs to, thereby allowing the receiver to recreate proper display timing of the data payload in a video stream.

42. The transmitter of claim 35 wherein the video header further comprises length information indicating the length of the data payload of the video packet.

43. The transmitter of claim 28 wherein the video information in the frame comprises video pixels representing uncompressed high definition video information.

44. A receiver for receiving one or more video packets over wireless channels, comprising:
a communication module configured to receive a video packet including a payload containing a segment of video information from a video frame, the video packet further including a video header including information describing said segment, wherein the video header uniquely defines the video information in the data payload; and
a depacketizer configured to extract video information from the video packet and uses the information in the video header to reconstruct the video frame.

45. The receiver of claim 44 wherein the communication module is configured to receive the video packet from a transmitter over a high data-rate channel.

46. The receiver of claim 45 wherein the communication module is further configured to send back an acknowledgment for the video packet to the transmitter over a low data-rate channel.

47. The receiver of claim 46 wherein the communication module is configured to receive the video packet from the transmitter via directional transmission beams over the high-rate channel, and to transmit back the acknowledgement to the transmitter by directional transmission over the low-rate channel.

48. The receiver of claim 44 wherein the video packet further includes a MAC header and a cyclic redundancy checksum (CRC).

49. The receiver of claim 44 wherein the depacketizer is further configured to utilize the information in the video header of the video packet to retrieve data from the video packet payload and recreate video information of the frame.

50. The receiver of claim 44 wherein the video header in each video packet uniquely defines the video information in the data payload of the video packet for the receiver to reconstruct the video frame for proper display of the data payload in a video stream.

51. The receiver of claim 50 wherein the video header comprises a media adaptation control field which includes a video frame start indicator that indicates whether the video packet data payload is the start of a video frame or field.

52. The receiver of claim 51 wherein the media adaptation control field further includes partitioning mode information that indicates a manner of pixel partitioning in frame segmentation for the packet payload.

53. The receiver of claim 51 wherein the media adaptation control field further includes encoding mode information that indicates the manner of any encoding of the video packet data payload by the sender.

54. The receiver of claim 51 wherein the video header further comprises video frame number information which, for progressive video information, indicates a sequence number of the video frame which the data payload of the video packet belongs to.

55. The receiver of claim 50 wherein the video header further comprises video frame number information which, for interlaced video information, indicates an even frame number for a packet in a first field of an interlaced frame and an odd frame number for a packet in a second field of an interlaced frame.

56. The receiver of claim 51 wherein the video header further comprises position information in the video frame which the video packet data payload starts from.

57. The receiver of claim 51 wherein the video header further comprises a playback deadline timestamp which, for interlaced video information, indicates the sampling instant of a field to which the data payload of the video packet belongs to, thereby allowing the receiver to recreate proper display timing of the data payload in a video stream.

58. The receiver of claim 51 wherein the video header further comprises length information indicating the length of the data payload of the video packet.
